(19) United States
(12) Patent Application Publication
(10) Pub. No.: US 2023/0381972 A1
(43) Pub. Date: Nov. 30, 2023

(54) CONTROL APPARATUS, ROBOT APPARATUS, CONTROL METHOD AND PROGRAM FOR A ROBOT APPARATUS

(71) Applicant: SONY GROUP CORPORATION, TOKYO (JP)

(72) Inventors: TOSHIMITSU TSUBOI, TOKYO (JP); SATOSHI SATO, TOKYO (JP); KEN KOBAYASHI, TOKYO (JP); FUMIKO SHIGA, TOKYO (JP)

(21) Appl. No.: 18/248,514

(22) PCT Filed: Oct. 12, 2021
(86) PCT No.: PCT/JP2021/037697

§ 371 Date: Apr. 10, 2023

(30) Foreign Application Priority Data
Oct. 22, 2020 (JP) 2020-177283

(51) Int. Cl. B25J 13/08; B25J 15/08

(52) U.S. Cl. CPC B25J 13/082; B25J 13/084; B25J 15/08

(57) ABSTRACT

[Object] To provide a control apparatus, a robot apparatus, a control method and a program for a robot apparatus that can detect and grip an end portion of a piece of cloth not spread.

[Solving Means] A control apparatus according to an embodiment of the present technology includes an acquisition unit, an operation command generation unit, and a determination unit. The acquisition unit acquires an output of a first pressure distribution sensor arranged on a gripping surface of a first hand and an output of a second pressure distribution sensor arranged on a gripping surface of a second hand. The operation command generation unit generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand. The determination unit determines whether or not the second hand reaches an end portion of the flexible thin object on the basis of the output of the second pressure distribution sensor.

### TECHNICAL FIELD

The present technology relates to a control apparatus of a robot that handles a flexible thin object such as a piece of cloth, to a robot apparatus including the same, and to a control method and a program therefor.

### BACKGROUND ART

For example, a capability of automizing handling and gripping pieces of cloth placed casually and arranging them to suitable places can automize some tasks at lodging and nursing facilities and can contribute to overcoming the human resources shortage, for example. As one of the related conventional technologies, for example, Patent Literature 1 has disclosed a spreading apparatus. The spreading apparatus detects a linear portion from an outline image of a piece of cloth. The spreading apparatus determines the detected linear portion as an edge portion of the piece of cloth. The spreading apparatus grips the determined edge portion of the piece of cloth with a plurality of finger portions.

### CITATION LIST

### Patent Literature

Patent Literature 1: Japanese Patent Application Laid-open No. 2010-561

### DISCLOSURE OF INVENTION

### Technical Problem

For example, for folding a piece of cloth, it is necessary to spread the entire piece of cloth in advance. For doing so, a robot needs to grip an end portion (edge portion or corner portion) of the piece of cloth. However, a method of determining the end portion of the piece of cloth on the basis of a camera image as described in Patent Literature 1 above requires spreading at least a region of the end portion of the piece of cloth in such a degree that the end portion can be determined. Therefore, the technology of Patent Literature 1 has high difficulties in finding an end portion of a piece of cloth not spread, a piece of cloth placed casually, or one of pieces of cloth stacked casually and gripping and spreading the end portion.

In view of the above-mentioned circumstances, it is an object of the present technology to provide a control apparatus, a robot apparatus, a control method and a program for a robot apparatus that can detect and grip an end portion of a piece of cloth not spread.

### Solution to Problem

A control apparatus according to an embodiment of the present technology includes an acquisition unit, an operation command generation unit, and a determination unit.

The acquisition unit acquires an output of a first pressure distribution sensor arranged on a gripping surface of a first hand and an output of a second pressure distribution sensor arranged on a gripping surface of a second hand.

The operation command generation unit generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand.

The determination unit determines whether or not the second hand reaches an end portion of the flexible thin object on the basis of the output of the second pressure distribution sensor.

The control apparatus is configured to determine whether or not the second hand reaches the end portion of the flexible thin object on the basis of a change in output of the second pressure distribution sensor when moving the second hand gripping the flexible thin object relative to the flexible thin object. This can detect and grip the end portion of the flexible thin object even in a case where the flexible thin object is placed casually.

The operation command generation unit may further generate a second gripping command for causing the first hand to grip a second predetermined portion that is proximity of the end portion of the flexible thin object gripped by the second hand.

The determination unit further determines whether or not the second predetermined portion is the end portion of the flexible thin object on the basis of the output of the first pressure distribution sensor.

The operation command generation unit may be configured to repeatedly generate the second gripping command until the first hand grips another end portion different from the one end portion of the flexible thin object with the second hand gripping one end portion of the flexible thin object.

The operation command generation unit may further generate a second movement command for moving the first hand relative to the flexible thin object toward a corner portion of the flexible thin object while keeping a gripping operation of the flexible thin object by the first hand.

In this case, the operation command generation unit may further generate a third movement command for moving the second hand relative to the flexible thin object toward another corner portion of the flexible thin object while keeping the gripping operation of the flexible thin object by the second hand with the first hand gripping one corner portion of the flexible thin object.

The predetermined direction may be a gravity direction. This can detect a lower end portion of the flexible thin object hanging from the first end portion.

The acquisition unit may be configured to further acquire information about a facing distance between gripping surfaces of the second hand gripping the first predetermined portion. In this case, the determination unit determines whether or not the first predetermined portion gripped by the second hand has a thickness of a single piece of the flexible thin object on the basis of the information about the facing distance.

The determination unit may be configured to determine that the second hand reaches the end portion of the flexible thin object when the determination unit determines, on the basis of a pressure distribution detected by the second pressure distribution sensor, that a boundary portion between a first region where a pressure value is a predetermined value or more and a second region where the pressure value is less than the predetermined value extends in at least one arbitrary axis direction.

In this case, the determination unit may be configured to determine that the second hand reaches the corner portion of the flexible thin object when the determination unit determines that the boundary portion between the first region and the second region extends in two axis directions intersecting with each other.

On the other hand, the determination unit may be configured to determine that the second predetermined portion is the end portion of the flexible thin object when the determination unit determines, on the basis of a pressure distribution detected by the first pressure distribution sensor, that a boundary portion between a first region where a pressure value is a predetermined value or more and a second region where the pressure value is less than the predetermined value extends in at least one arbitrary axis direction.

The acquisition unit may further acquire information about weight of the flexible thin object gripped by the first hand. In this case, the determination unit determines whether or not weight of the flexible thin object gripped by the first hand is weight of a single piece of the flexible thin object on the basis of the information about the weight.

The operation command generation unit may be configured to further generate a folding command for causing corner portions of the flexible thin object to meet each other.

In this case, the folding command may be configured to perform an operation of causing a first corner portion gripped by the first hand to meet a second corner portion and causing a third corner portion gripped by the second hand to meet a fourth corner portion, the second corner portion being opposite to the first corner portion in a gravity direction, the fourth corner portion being opposite to the third corner portion in the gravity direction.

A robot apparatus according to an embodiment of the present technology includes a first hand, a second hand, and a control circuit.

The first pressure distribution sensor is arranged on a gripping surface of a first hand.

The second pressure distribution sensor is arranged on a gripping surface of a second hand.

The control circuit includes an acquisition unit, an operation command generation unit, and a determination unit.

The acquisition unit acquires an output of the first pressure distribution sensor and an output of the second pressure distribution sensor.

The operation command generation unit generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand.

The determination unit determines whether or not the second hand reaches an end portion of the flexible thin object on the basis of the output of the second pressure distribution sensor.

A control method for a robot apparatus according to an embodiment of the present technology includes:
causing a second hand to grip a first predetermined portion of the flexible thin object gripped by a first hand;
moving the second hand relative to the flexible thin object in a predetermined direction from the first predetermined portion while keeping a gripping operation of the flexible thin object by the second hand; and
determining whether or not the second hand reaches an end portion of the flexible thin object on the basis of the output of a second pressure distribution sensor arranged on a gripping surface of the second hand.

A program according to an embodiment of the present technology causes a control apparatus of a robot apparatus to execute:
a step of causing a second hand to grip a first predetermined portion of the flexible thin object gripped by a first hand;
a step of moving the second hand relative to the flexible thin object in a predetermined direction from the first predetermined portion while keeping a gripping operation of the flexible thin object by the second hand; and
a step of determining whether or not the second hand reaches an end portion of the flexible thin object on the basis of the output of a second pressure distribution sensor arranged on a gripping surface of the second hand.

### BRIEF DESCRIPTION OF DRAWINGS

FIG. 1 A schematic configuration diagram of a robot apparatus according to an embodiment of the present technology.

FIG. 2 A side view showing details of a first hand and a second hand of the robot apparatus.

FIG. 3 A schematic side cross-sectional view showing a configuration example of a pressure distribution sensor arranged in each hand.

FIG. 4 A block diagram showing a configuration of a control circuit of the robot apparatus.

FIG. 5 A flowchart schematically showing an overall operation procedure of the robot apparatus.

FIG. 6 A flowchart showing a procedure of first operation process performed in the control circuit.

FIG. 7 A flowchart showing a procedure of second operation process performed in the control circuit.

FIG. 8 A schematic diagram of the robot apparatus showing a procedure of the second operation process.

FIG. 9 A schematic diagram of the robot apparatus showing a procedure of the second operation process.

FIG. 10 A schematic diagram of the robot apparatus showing the procedure of the second operation process.

FIG. 11 A schematic diagram of the robot apparatus showing the procedure of the second operation process.

FIG. 12 A schematic diagram of the robot apparatus showing the procedure of the second operation process.

FIG. 13 A schematic view showing a relationship between a gripping position of a piece of cloth that is a gripping target object and an output of the pressure distribution sensor.

FIG. 14 A schematic side view showing an example of the hand gripping the piece of cloth.

FIG. 15 A schematic side view showing another example of the hand gripping the piece of cloth.

FIG. 16 A schematic side view showing still another example of the hand gripping the piece of cloth.

FIG. 17 A diagram describing a cloth folding method using the robot apparatus.

### MODE(S) FOR CARRYING OUT THE INVENTION

Hereinafter, embodiments according to the present technology will be described with reference to the drawings.

[Robot Apparatus]

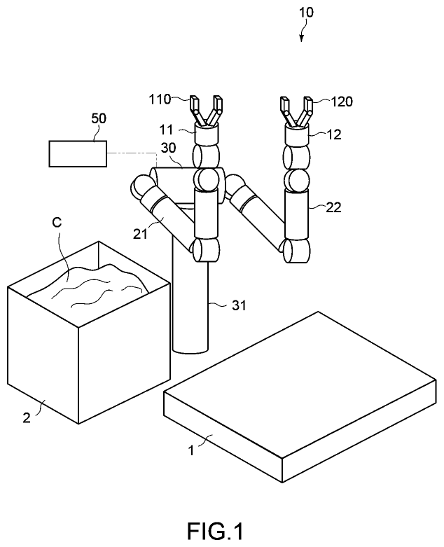

FIG. 1 is a schematic configuration diagram of a robot apparatus according to an embodiment of the present technology. A robot apparatus 10 according to the present embodiment includes a first arm 21 and a second arm 22. The first arm 21 has a first hand 11. The second arm 22 has a second hand 12. The first arm 21 and the second arm 22 are articulated arms. The first arm 21 and the second arm 22 are configured to be capable of moving the first hand 11 and the second hand 12 to an arbitrary position in an arbitrary attitude, respectively.

A drive unit 30 supports both the first arm 21 and the second arm 22. The drive unit 30 includes various actuators and driving circuits (electric circuit and fluid pressure circuit) for driving the respective parts of the first and second hands 11, 12 and the first and second arms 21, 22. The drive unit 30 controls driving of the respective parts on the basis of operation commands output from a control circuit 50 to be described later. The drive unit 30 is installed at a predetermined height position on a work table 1 via a base table 31. The drive unit 30 is configured to be rotatable around the base table 31.

The robot apparatus 10 performs an operation of taking out a piece of cloth C that is a handling target object from storage 2 disposed on the side of the base table 31 and spreading the taken-out piece of cloth C and folding it on the work table 1 in accordance with a procedure to be described later. The storage 2 stores a plurality of pieces of cloth C stacked. The way of storing the pieces of cloth C is not particularly limited, and the pieces of cloth C may be stacked casually.

The piece of cloth C is a flexible or deformable thin object (hereinafter, also referred to as a flexible thin object). The piece of cloth C is, for example, a towel or bed sheet. The piece of cloth C is typically rectangular. However, the piece of cloth C may have other shape. Moreover, the piece of cloth C is not limited to a regular shape, and the piece of cloth C may be a shirt or the like. The flexible thin object may be another material such as a vinyl sheet other than the piece of cloth.

(First and Second Hands)

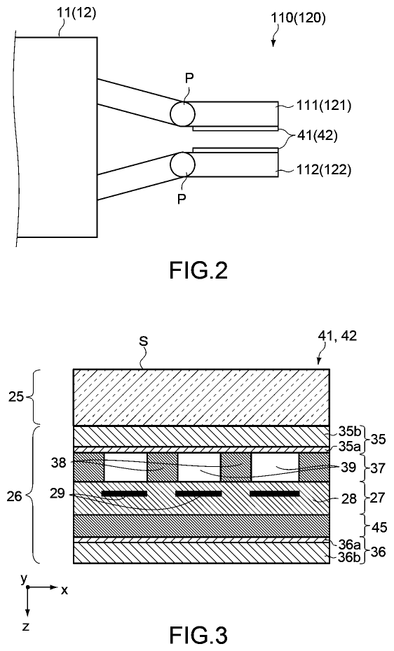

FIG. 2 is a side view showing details of the first hand 11 and the second hand 12. The first hand 11 and the second hand 12 have the same configuration. The reference signs with brackets in the figure indicate components associated with the second hand 12.

The first hand 11 has a first finger unit 110. The first finger unit 110 is constituted by two finger grippers. The two finger grippers include two finger portions 111, 112 facing each other. The respective finger portions 111, 112 have articulated structures each having a rotational axis P. The respective finger portions 111, 112 are movable in a direction in which they move closer to or away from each other with distal end portions of the respective finger portions 111, 112 parallel to each other. Inner surface sides of the respective finger portions 111, 112 are formed as gripping surfaces that can grip a handling target object (piece of cloth C). First pressure distribution sensors 41 are respectively arranged in the gripping surfaces.

Similarly, the second hand 12 has a second finger unit 120. The second finger unit 120 is constituted by two finger grippers. The two finger grippers include two finger portions 121, 122 facing each other. The respective finger portions 121, 122 have articulated structures each having a rotational axis P. The respective finger portions 121, 122 are movable in a direction in which they move closer to or away from each other with distal end portions of the respective finger portions 121, 122 parallel to each other. Inner surface sides of the respective finger portions 121, 122 are formed as gripping surfaces that can grip a handling target object (piece of cloth C). Second pressure distribution sensors 42 are respectively arranged in the gripping surfaces.

The first pressure distribution sensors 41 and the second pressure distribution sensors 42 have detection surfaces S (see FIG. 3) parallel to the gripping surfaces. The first pressure distribution sensors 41 and the second pressure distribution sensors 42 detect distributions on the surfaces of pressures acting on the detection surfaces S. The first pressure distribution sensor 41 may be arranged in only one of the two finger portions 111, 112. Similarly, the second pressure distribution sensor 42 may be arranged in only one of the two finger portions 121, 122. The first and second pressure distribution sensors 41, 42 have the same configuration. The first and second pressure distribution sensors 41, 42 are constituted by capacitive pressure sensors as shown in FIG. 3, for example.

(First and Second Pressure Distribution Sensors)

FIG. 3 is a schematic side cross-sectional view showing a configuration example of the first or second pressure distribution sensor 41, 42. As shown in the figure, the first or second pressure distribution sensor 41, 42 includes a clearance layer 25 and a sensor portion 26 in the stated order from the upper side (outside) in a stacking direction (z-axis direction) perpendicular to the gripping surface.

Stacking a first electrode film layer 35, a deformation layer 37, a sensor electrode layer 27, a fixation layer 45, and a second electrode film layer 36 in the stated order from the upper side (outside) in the stacking direction (z-axis direction) configures the sensor portion 26. The sensor electrode layer 27 is flexible. The sensor electrode layer 27 includes a base material 28 and a plurality of sensing portions 29. The plurality of sensing portions 29 is arranged in a matrix form inside the surface of the base material 28.

The sensing portions 29 are capacitive sensors. The sensing portions 29 are arrayed regularly at predetermined intervals in a width-wise direction (x-direction) and a length-wise direction (y-direction) in the sensor electrode layer 27. The respective sensing portions 29 have a comb-like pulse electrode and a comb-like sensor electrode (not shown), for example.

The first electrode film layer 35 and the second electrode film layer 36 are positioned sandwiching the sensor electrode layer 27 in the stacking direction (z-axis direction). The first electrode film layer 35 is flexible. Stacking a first film layer 35b and a first reference electrode layer 35a configures the first electrode film layer 35. The second electrode film layer 36 is also flexible. Stacking a second film layer 36b and a second reference electrode layer 36a configures the second electrode film layer 36. The first reference electrode layer 35a and the second reference electrode layer 36a are grounding electrodes and connected to the ground potential.

The fixation layer 45 is provided between the sensor electrode layer 27 and the second electrode film layer 36. The fixation layer 45 adjusts a distance (gap) in the stacking direction (z-axis direction) between the sensor electrode layer 27 and the second reference electrode layer 36a.

The deformation layer 37 is provided between the sensor electrode layer 27 and the first electrode film layer 35. The deformation layer 37 is configured to be elastically deformable in accordance with an external force added by a user. The deformation layer 37 has patterning structures and hollow portions 39. The hollow portions 39 have no patterning structures. The patterning structures are constituted by a plurality of column portions 38 arrayed spaced apart from each other in a direction (xy-direction) parallel to each layer. Moreover, the hollow portions 39 are portions with no column portions 38. The plurality of column portions 38 in the deformation layer 37 is arranged at positions not corresponding to the sensing portions 29 in the sensor electrode layer 27 in the stacking direction (z-axis direction).

The clearance layer 25 arranged to face the first electrode film layer 35 outside the sensor portion 26. This clearance layer 25 is stacked on the sensor portion 26, having the adhesive layer therebetween. The clearance layer 25 forms the gripping surface of the first or second hand 11, 12. The clearance layer 25 is constituted by a partially elastically deformable material. The partially elastically deformable material is, for example, a resin sheet, a rubber sheet, or leather.

The second electrode film layer 36 of the first or second pressure distribution sensor 41, 42 is attached to each finger portion 111, 112, 121, 122. The surface of the clearance layer 25 serves as the detection surface S that constitutes the gripping surface.

In the first and second pressure distribution sensors 41, 42 configured in the above-mentioned manner, adding an external force to the detection surface S deforms the clearance layer 25 and pushes the first electrode film layer 35 directly beneath it toward the sensor electrode layer 27. Pushing the first electrode film layer 35 elastically deforms the deformation layer 37. This moves the first reference electrode layer 35a (ground potential) closer to the sensing portion 29 of the sensor electrode layer 27. At this time, the capacitance between the pulse electrode and the sensor electrode in the sensing portion 29 changes. The first or second pressure distribution sensor 41, 42 detects a pushing pressure based on the amount of change of the capacitance. This can detect a pressure distribution on the basis of coordinates of the sensing portion 29. The first or second pressure distribution sensor 41, 42 may be configured to be capable of detecting a shearing force acting on the detection surface S and its distribution other than the pressure distribution on the detection surface S.

(Control Circuit)

The robot apparatus 10 further includes the control circuit 50 (control apparatus). The control circuit 50 (control apparatus) controls operations of the respective parts such as the first and second hands 11, 12 and the first and second arms 21, 22. The control circuit 50 may be arranged inside the drive unit 30 or may be configured as a unit different from the drive unit 30.

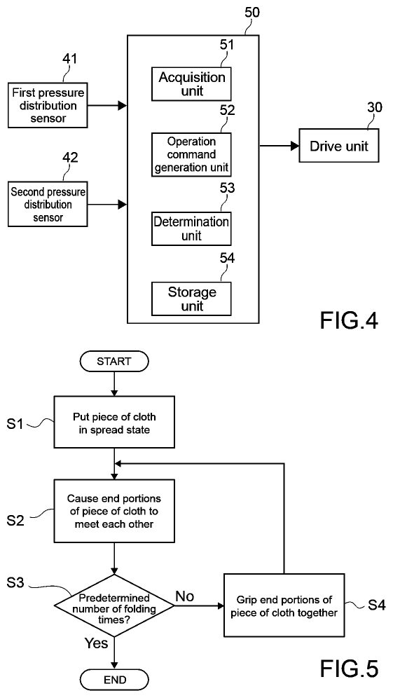

FIG. 4 is a block diagram showing a configuration of the control circuit 50. The control circuit 50 is constituted by a computer including a central processing unit (CPU) and a memory. The control circuit 50 performs various functions to be described later by executing a program stored in the memory. The control circuit 50 includes an acquisition unit 51, an operation command generation unit 52, and a determination unit 53 as its functional blocks.

The acquisition unit 51 acquires outputs of the first pressure distribution sensors 41 and outputs of the second pressure distribution sensors 42. The acquisition unit 51 is configured to be capable of further acquiring outputs of various sensors for detecting attitudes and positions, operation statuses, and the like of the first hand 11, the second hand 12, the first arm 21, and the second arm 22 of the robot apparatus 10. The control circuit 50 detects positions, attitudes, and the like of the first hand 11 and the second hand 12 on the basis of the outputs of the various sensors. Examples of the various sensors include an angle sensor, an angular velocity sensor, a torque sensor, a force and moment sensor, a current sensor, a thermal sensor, and a camera.

Based on the outputs of the first and second pressure distribution sensors 41, 42, the acquisition unit 51 detects gripping forces to the piece of cloth C gripped by the finger units 110, 120 of the first and second hands 11, 12 and their distributions on the surfaces, for example. Based on the outputs of the first and second pressure distribution sensors 41, 42, the acquisition unit 51 detects a position and the like of the piece of cloth gripped by the first and second hands 11, 12.

Based on the outputs of the various sensors, the acquisition unit 51 further acquires respective types of information about weight and thickness of the piece of cloth C gripped by the first hand 11 or the second hand 12, a relative position between the first hand 11 and the second hand 12, and a facing distance between the gripping surfaces of the first hand 11 and the second hand 12 (in the present embodiment, the detection surfaces S of the first and second pressure distribution sensors 41, 42), for example.

Based on the outputs of the first and second pressure distribution sensors 41, 42 and the various sensors, the operation command generation unit 52 generates various operation commands that drive the first and second hands 11, 12 and the first and second arms 21, 22. As will be described later, the operation command generation unit includes gripping commands of the piece of cloth C to the first and second hands 11, 12 and movement commands of the piece of cloth C to the first and second hands 11, 12, for example. The gripping commands of the piece of cloth C include a high-level gripping command (hereinafter, also referred to as a tight gripping command) for keeping a gripping position of the piece of cloth C, a low-level gripping command (hereinafter, also referred to as a soft gripping command) for gripping the piece of cloth C with a gripping force capable of moving (sliding operation) relative to the piece of cloth C, and a gripping canceling command for canceling the gripping operation of the piece of cloth C.

The operation command generation unit 52 generates an operation command for controlling driving of the first and second hands 11, 12 to make operations of spreading and folding a piece of cloth C taken-out from the storage in a procedure as will be described later. The operation command generation unit 52 functions to plan respective operations such as a gripping operation, a spreading operation, and a folding operation of the piece of cloth C and control these operations.

As will be described later, the determination unit 53 is configured to determine whether or not a gripping position of the piece of cloth C by the first or second hand 11, 12 is an end portion of the piece of cloth C on the basis of the output of the first or second pressure distribution sensor 41, 42. Moreover, the determination unit 53 is configured to determine whether or not a thickness of the piece of cloth C gripped by the first or second hand 11, 12 is equivalent to a thickness of a single piece of cloth and further determine whether or not weight of the piece of cloth C gripped by the first or second hand 11, 12 is equivalent to weight of the single piece of cloth.

Here, in the present embodiment where the piece of cloth C is rectangular, the end portion of the piece of cloth C means an edge portion corresponding to each side of the piece of cloth C or any one corner portion of four corner portions of the piece of cloth C. Hereinafter, unless otherwise stated, the edge portion and the corner portion of the piece of cloth C will be both referred to as the end portion of the piece of cloth C.

The control circuit 50 further includes a storage unit 54. The storage unit 54 is constituted by a read only memory (ROM) or a random access memory (RAM). The storage unit 54 stores programs, control parameters, and the like for causing the robot apparatus 10 to perform various operations to be described later. The storage unit 54 further stores size and shape of the piece of cloth C, thickness and weight of the single piece of cloth, and the like.

[Operation of Robot Apparatus]

Next, details of the control circuit 50 will be described with an operation of the robot apparatus 10. FIG. 5 is a flowchart schematically showing an overall operation procedure of the robot apparatus 10.

As shown in the figure, the robot apparatus 10 takes out a piece of cloth C from the storage 2 and spreads the piece of cloth C (puts it in a spread state) (Step 1). A spreading process of the piece of cloth C includes an operation of gripping end portions (in this example, corner portions) of the piece of cloth C as will be described later.

Subsequently, a process of folding an end portion (in this example, a corner portion) of the piece of cloth to meet another one is performed (Step 2). In the present embodiment, a folding process of the piece of cloth C is performed on the work table 1 as will be described later. The folding process is performed a predetermined number of times. For example, the number of folding times is one in a case where the piece of cloth C is folded in two. For example, the number of folding times is two in a case where the piece of cloth C is folded in four. In a case where the number of folding times is less than the predetermined number of times (No in Step 3), the meeting end portions (in this example, the meeting corner portions) of the piece of cloth C are gripped by the first and second hands 11, 12 and the processes of Steps 2 and 3 is performed again (Step 4). On the other hand, in a case where the number of folding times reaches the predetermined number of times (Yes in Step 3), the process of folding the piece of cloth C ends. Then, a new piece of cloth C is taken out from the storage 2 and the above-mentioned processes are repeatedly performed.

(Spreading Process)

Next, details of the above-mentioned spreading process (Step 1) will be described. The spreading process includes a first operation process and a second operation process. The first operation process takes out only one piece of cloth C from the storage 2. The second operation process spreads the taken-out piece of cloth C.

(1) First Operation Process

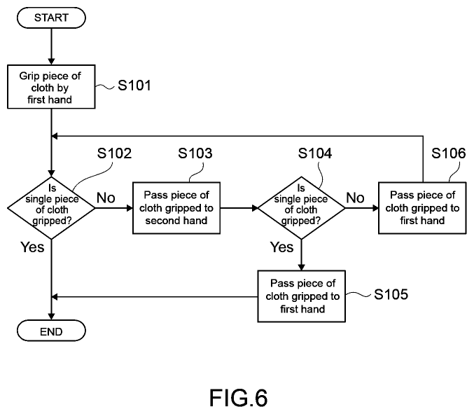

FIG. 6 is a flowchart showing a procedure of the first operation process performed in the control circuit 50. Hereinafter, unless otherwise stated, the respective processes to be described later are performed based on operation commands output from the control circuit 50 (the operation command generation unit 52).

The robot apparatus 10 first grips a piece of cloth C in the storage 2 with the first hand 11 (Step 101). The first arm 21 transports the piece of cloth C to a predetermined height position above the storage 2. The predetermined height position is, for example, such a height position that the lower end portion of the piece of cloth C hanging from the first hand 11 does not touch other pieces of cloth C inside the storage 2. This can cause the entire weight of the piece of cloth C gripped by the first hand 11 to act on the first hand 11.

Subsequently, the robot apparatus 10 determines whether or not the piece of cloth C gripped by the first hand 11 is a single piece (Step 102). The determination unit 53 of the control circuit 50 performs this determination process. Whether or not the piece of cloth C gripped by the first hand 11 is a single piece can be determined on the basis of the weight of the piece of cloth C acting on the first hand 11. The weight of the piece of cloth C may be detected on the basis of the outputs of the first pressure distribution sensors 41. Alternatively, outputs of other force sensors configured separately from the first pressure distribution sensors 41 may be used.

In a case where the piece of cloth C gripped by the first hand 11 is not a single piece (e.g., in a case where the determination unit 53 determines that the weight is equivalent to the weight of two pieces) as a determination result of the determination unit 53, the robot apparatus 10 passes the piece of cloth C gripped from the first hand 11 to the second hand 12 (Step 103). In this case, the second hand 12 may grip the piece of cloth C at a proximate position of the first hand 11 (e.g., next to the first hand 11 or below the first hand 11). The second hand 12 can detect the piece of cloth C on the basis of the outputs of the second pressure distribution sensors 42.

The robot apparatus 10 further determines whether or not the piece of cloth C received by the second hand 12 is a single piece (Step 104). The operation of passing the piece of cloth C from the first hand 11 to the second hand 12 causes a piece(s) of cloth overlapping the piece of cloth C to fall easily. Therefore, the determination unit 53 further determines the weight of the piece of cloth C gripped by the second hand 12.

In a case of determining that the piece of cloth C gripped by the second hand 12 is a single piece, the robot apparatus 10 passes the piece of cloth C from the second hand 12 to the first hand 11 and starts the next process (second operation process) (Step 105). On the other hand, in a case of determining that the piece of cloth C gripped by the second hand 12 is not a single piece, the robot apparatus 10 passes the piece of cloth C from the second hand 12 to the first hand 11 and determines the number of pieces of cloth C received by the first hand 11 again (Step 106). The operation of passing the piece of cloth C between the first hand 11 and the second hand 12 repeats until the piece of cloth C becomes a single piece.

(2) Second Operation Process

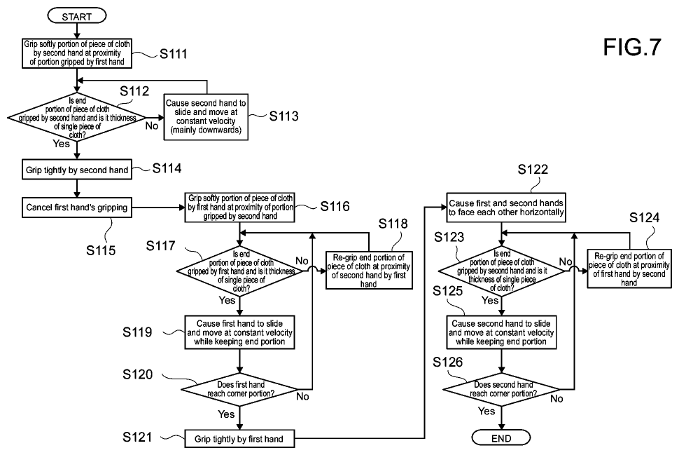

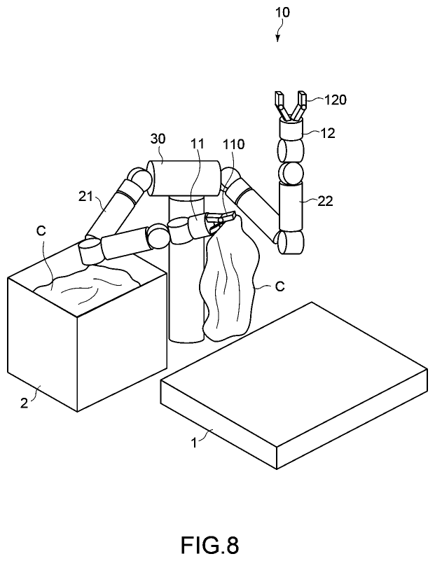

FIG. 7 is a flowchart showing a procedure of the second operation process performed in the control circuit 50. Hereinafter, unless otherwise stated, the respective processes to be described later are performed based on operation commands output from the control circuit 50 (the operation command generation unit 52). FIGS. 8 to 12 are schematic diagrams showing the procedure of the second operation process of the robot apparatus 10.

As shown in FIG. 8, the second operation process starts with the first hand 11 gripping the piece of cloth C that is the single piece as a result of the above-mentioned first operation process. The second operation process is typically performed in accordance with the following procedure after transporting the piece of cloth C at a position directly above the work table 1.

(Process of Gripping End Portion by Second Hand)

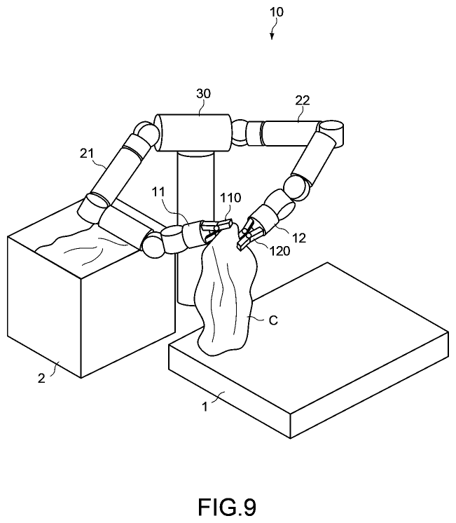

The control circuit 50 first generates an operation command (first gripping command) that causes the second hand 12 to grip a predetermined portion (first predetermined portion) of the piece of cloth C gripped by the first hand 11 (Step 111 in FIG. 9).

The gripping command to the second hand 12 at this time is a soft gripping command that causes the second hand 12 to move (sliding operation) relative to the piece of cloth C. The predetermined portion (first predetermined portion) is not particularly limited. However, the predetermined portion (first predetermined portion) is favorably the proximity of the gripping position of the piece of cloth C by the first hand 11. This enables the second hand 12 to relatively easily perform the gripping operation of the piece of cloth C.

Subsequently, the control circuit 50 determines whether or not the predetermined portion (first predetermined portion) of the piece of cloth C gripped by the second hand 12 is the end portion of the piece of cloth C and whether or not the thickness of the piece of cloth C gripped by the second hand 12 is a thickness of a single piece of cloth C (Step 112).

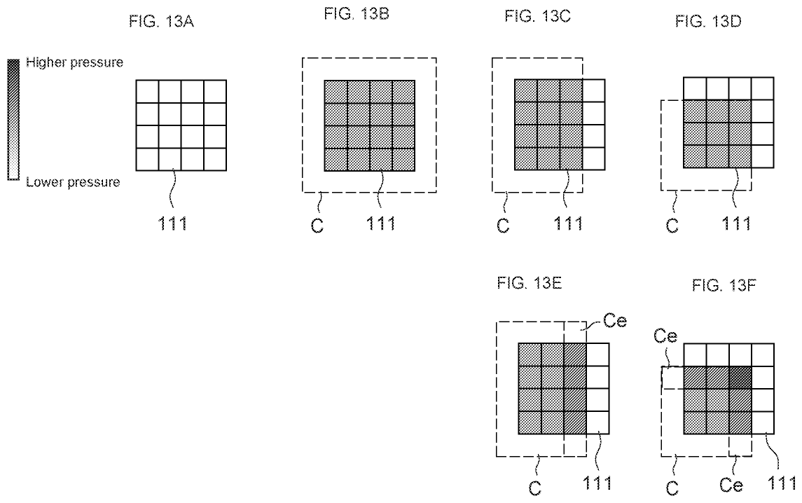

The outputs of the second pressure distribution sensors 42 are referenced for determining whether or not the position of the piece of cloth C gripped by the second hand 12 is the end portion of the piece of cloth C. FIG. 13 is a schematic view showing a relationship between the gripping position of the piece of cloth C and the outputs of the second pressure distribution sensors 42.

As shown in FIG. 13 (a), the plurality of sensing portions 29 (see FIG. 3) divides the detection surfaces S of the second pressure distribution sensors 42 into a plurality of detection regions. As shown in FIG. 13 (b), when the detection surfaces S are not located at the end portion of the piece of cloth C, the entire detection surfaces S are in contact with the piece of cloth C. Therefore, the second pressure distribution sensors 42 detect a substantially constant pressure in each of the detection regions of the detection surfaces S. In this case, the determination unit 53 determines that the second hand 12 is not gripping the end portion of the piece of cloth C.

On the other hand, as shown in FIGS. 13 (c) and (d), when the end portion of the piece of cloth C is positioned on the detection surfaces S, the second pressure distribution sensors 42 detect different pressures at different detection regions.

For example, when the edge portion of the piece of cloth C is positioned on the detection surfaces S, the boundary portion between a first region where a pressure value is a predetermined value or more (in the figure, the darker-color region) and a second region where the pressure value is less than the predetermined value (in the figure, the lighter-color region) extends in at least one arbitrary axis direction as shown in FIG. 13 (c). That is, the determination unit 53 determines that the second hand 12 is gripping the edge portion of the piece of cloth C when such a boundary portion is formed in the arbitrary one axis direction on the detection surfaces S.

Moreover, the determination unit 53 determines that the second hand 12 is gripping the corner portion of the piece of cloth C when determining that the boundary portion between the first region and the second region extends in two axis directions intersecting with each other as shown in FIG. 13 (d).

The above-mentioned predetermined value is not particularly limited. Typically, the predetermined value is set to be a value that can distinguish a contact region with the piece of cloth C from a contactless region.

It should be noted that in a case where the end portion of the piece of cloth C has a folded portion, as shown in FIGS. 13 (e) and (f), a pressure value in a detection region corresponding to a folded portion Ce is higher than pressure values in other detection regions. Also in such a case, setting a contact region including the folded portion Ce as the above-mentioned first region can determine whether or not the end portion (edge portion, corner portion) of the piece of cloth C is located on the detection surfaces S.

Moreover, a thickness of the piece of cloth C gripped by the second hand 12 is detected on the basis of a facing distance between the gripping surfaces of the second hand 12.

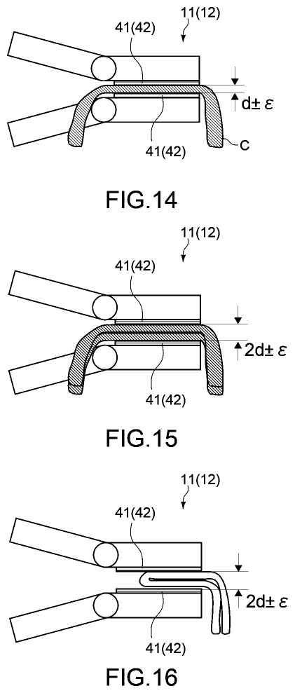

For example, provided that d denotes an average thickness per single piece of the piece of cloth C, the facing distance between the gripping surfaces of the second hand 12 is d±c (c indicates an arbitrary value less than d) as shown in FIG. 14 in a case where the thickness of the piece of cloth C gripped by the second hand 12 is equivalent to the thickness of the single piece. Moreover, the facing distance between the gripping surfaces of the second hand 12 is 2d±ε as shown in FIGS. 15 and 16 in a case where the thickness of the piece of cloth C gripped by the second hand 12 is equivalent to the thickness of two pieces. FIG. 15 shows a state when two pieces of cloth C are gripped at the same time. FIG. 16 shows a state when a single piece of cloth C is folded and gripped.

Similarly, in a case where the thickness of the piece of cloth C gripped by the second hand 12 is equivalent to a thickness of three pieces, the facing distance between the gripping surfaces of the second hand 12 is 3d±ε. In addition, in a case where the thickness of the piece of cloth C gripped by the second hand 12 is equivalent to a thickness of four pieces, the facing distance between the gripping surfaces of the second hand 12 is 4d±ε. A thickness of the piece of cloth C gripped by the first hand 11 can be detected in a similar way. In this way, the facing distance between the gripping surfaces is substantially discrete. Therefore, acquiring data about the facing distance between the gripping surfaces corresponding to the number of pieces of cloth C in advance can determine the number of pieces of cloth C gripped by the first or second hand 11, 12.

On the other hand, the output of the first or second pressure distribution sensor 41, 42 may be referenced for determining whether or not the thickness of the piece of cloth C gripped by the first or second hand 11, 12 is equivalent to the thickness of the single piece. For example, an output of the first or second pressure distribution sensor 41, 42 (hereinafter, also referred to as a reference value) when gripping the piece of cloth C that is the single piece with a constant gripping force is stored in advance. Then, in a case where the output of the first or second pressure distribution sensor 41, 42 when gripping the piece of cloth C with such a constant gripping force exceeds the reference value, the determination unit 53 can determine that the thickness of the piece of cloth C gripped is equivalent to the thickness of two or more pieces.

For example, as shown in FIG. 9, in a case where the gripping region of the piece of cloth C by the second hand 12 is not the end portion of the piece of cloth C (No in Step 112), the control circuit 50 generates an operation command (first movement command) that causes the second hand 12 to move (slide) relative to the piece of cloth C in a predetermined direction from the above-mentioned first predetermined portion while keeping the gripping operation of the piece of cloth C by the second hand 12 (Step 113).

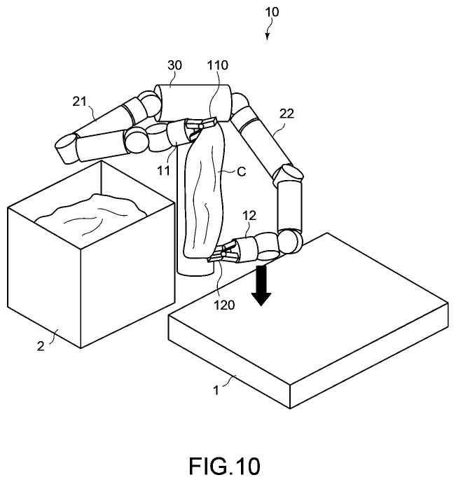

At this time, the first hand 11 grips the piece of cloth C with a relatively high-level gripping force so as not to move with respect to the piece of cloth C. This moves the second hand 12 away from the first hand 11 while applying a constant tensile force on the piece of cloth C between the first hand 11 and the second hand 12. A movement velocity of the second hand 12 is not particularly limited. Typically, the second hand 12 is moved relative to the first hand 11 and the piece of cloth C at a constant velocity. A movement direction (the above-mentioned predetermined direction) of the second hand 12 is also not particularly limited. In the present embodiment, the second hand 12 is moved in the lower direction (gravity direction) (see FIG. 10).

During the movement of the second hand 12, the determination unit 53 determines whether or not the second hand 12 reaches the end portion of the piece of cloth C on the basis of the outputs of the second pressure distribution sensors 42 (Step 112).

For example, in a case where a gripping start position (first predetermined portion) of the second hand 12 is not the end portion of the piece of cloth C, sliding the second hand 12 downward with respect to the piece of cloth C causes the second hand 12 to finally reach the lower end portion (edge portion or corner portion) of the piece of cloth C. Then, the determination unit 53 determines that the second hand 12 reaches the end portion of the piece of cloth C when the second pressure distribution sensors 42 output a pressure distribution as shown in FIG. 13 (c) to (f).

On the other hand, the thickness of the piece of cloth C at the gripping start position (first predetermined portion) of the second hand 12 is not equivalent to the single piece (see FIGS. 15 and 16), sliding the second hand 12 downward with respect to the piece of cloth C typically causes the second hand 12 to go beyond an overlapping region of the piece of cloth C and reach a region with the thickness of the single piece of cloth C. That is, although the overlapping region of the piece of cloth C is randomly made, the overlapping region rarely extends to the lower end portion of the piece of cloth C. In particular, moving the second hand 12 downwards makes the lower end portion of the piece of cloth C easily visible due to the self-weight action of the piece of cloth C. It makes it easier to determine whether or not the second hand 12 reaches the lower end portion of the piece of cloth C.

It should be noted that the above-mentioned operation of Step 113 is repeated in a case where the thickness of the piece of cloth C at the lower end portion gripped by the second hand 12 is not still equivalent to the thickness of the single piece.

As shown in FIG. 10, when the second hand 12 reaches the lower end portion of the piece of cloth C, the control circuit 50 stops the movement of the second hand 12 and changes the gripping force on the piece of cloth C at that position from the soft gripping command to the tight gripping command (Step 114). Accordingly, the second hand 12 stably grips the lower end portion of the piece of cloth C.

Then, the control circuit 50 generates an operation command for canceling the gripping operation of the piece of cloth C to the first hand 11 and releases the first hand 11 from the piece of cloth C (Step 115). At this time, inverting the vertical positions of the first hand 11 and the second hand 12 may change the position of the second hand 12 so that the second hand 12 is positioned above the first hand 11.

(Process of Gripping Corner Portion by First Hand)

Subsequently, the control circuit 50 generates an operation command (second gripping command) that causes the first hand 11 to grip a predetermined portion (second predetermined portion) that is the proximity of the end portion of the piece of cloth C gripped by the second hand 12 (Step 116).

The gripping command to the first hand 11 at this time is a soft gripping command that causes the first hand 11 to move (sliding operation) relative to the piece of cloth C. The predetermined portion (second predetermined portion) is not particularly limited. However, the predetermined portion (second predetermined portion) is favorably the proximity of the gripping position of the piece of cloth C by the second hand 12. This enables the first hand 11 to relatively easily perform the gripping operation of the piece of cloth C.

Subsequently, the control circuit 50 determines whether or not the predetermined portion (second predetermined portion) of the piece of cloth C gripped by the first hand 11 is the end portion of the piece of cloth C and whether or not the thickness of the piece of cloth C gripped by the first hand 11 is the thickness of the single piece of cloth C (Step 117).

The determination as to the gripping position and the thickness of the piece of cloth C by the first hand 11 is similar to that in Step 112 described above. Therefore, the description is omitted here.

In a case where the gripping region of the piece of cloth C by the first hand 11 is not the end portion of the piece of cloth C or the thickness of the piece of cloth C gripped is not the thickness of the single piece of cloth C (No in Step 117), the control circuit 50 generates an operation command for changing the gripping position of the piece of cloth C by the first hand 11 and re-gripping another position (Step 118). This process is repeatedly performed until the control circuit 50 determines that the predetermined portion (second predetermined portion) of the piece of cloth C gripped by the first hand 11 is the end portion of the piece of cloth C and that the thickness of the piece of cloth C gripped by the first hand 11 is the thickness of the single piece of cloth C.

It should be noted that a process similar to Step 113 described above may replace such a process. That is, the control circuit 50 may generate an operation command (second movement command) that causes the first hand 11 to move (slide) relative to the piece of cloth C in a second predetermined direction from the above-mentioned second predetermined portion while keeping the soft gripping operation of the piece of cloth C by the first hand 11.

Subsequently, the control circuit 50 further generates an operation command (second movement command) that causes the first hand 11 to move relative to the piece of cloth C toward the corner portion of the piece of cloth C at a constant velocity while keeping the gripping operation (soft gripping operation) of the end portion of the piece of cloth C by the first hand 11 (Step 119).

The first hand 11 is gripping the end portion (typically, the edge portion) of the piece of cloth C that is the proximity of the second hand 12. Therefore, there is a high possibility that the first hand 11 is gripping the same side as the edge portion of the piece of cloth C gripped by the second hand 12. Moreover, the piece of cloth C hangs in the gravity direction from the second hand 12. Therefore, the movement direction of the first hand 11 is favorably a direction away from the first hand 12 in the gravity direction. It should be noted that the movement direction of the first hand 11 may be a direction away from the second hand 12 horizontally.

It should be noted that the movement direction of the first hand 11 may be determined based on a pressure distribution detected by the first pressure distribution sensors 41. For example, in a case where the first pressure distribution sensors 41 detect the pressure distribution as shown in FIG. 13 (c), a direction (in FIG. 13 (c), the vertical direction) in which the boundary portion between the first region (contact region) and the second region (contactless region) extends is determined as the movement direction of the first hand 11. This can move the first hand 11 toward the corner portion of the piece of cloth C.

During the movement of the first hand 11, the determination unit 53 determines whether or not the first hand 11 reaches the corner portion of the piece of cloth C on the basis of the outputs of the first pressure distribution sensors 41 (Step 120).

When the first hand 11 reaches the corner portion of the piece of cloth C, the control circuit 50 stops the movement of the first hand 11 and changes the gripping force on the piece of cloth C at that position from the soft gripping command to the tight gripping command (Step 121). Accordingly, the first hand 11 stably grips one corner portion of the piece of cloth C.

(Process of Gripping Corner Portion by Second Hand)

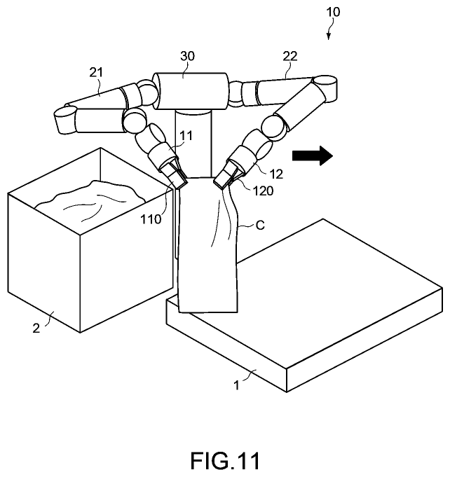

Subsequently, as shown in FIG. 11, the control circuit 50 generates an operation command that drives each of the first arm 21 and the second arm 22 so that the first hand 11 and the second hand 12 face each other horizontally (Step 122).

The determination unit 53 determines whether or not the second hand 12 is gripping the end portion of the piece of cloth C and the thickness of the piece of cloth C is a thickness of a single piece thereof (Step 123). In a case where the gripping region of the piece of cloth C by the second hand 12 is not the end portion of the piece of cloth C or the thickness of the piece of cloth C gripped is not the thickness of the single piece of cloth C (No in Step 123), the control circuit 50 generates an operation command for changing the gripping position of the piece of cloth C by the second hand 12 and re-gripping the end portion (typically, the edge portion) of the piece of cloth C that is the proximity of the first hand 11 (Step 124).

It should be noted that the conditions of Step 123 are satisfied typically as a result of the processes of Steps 112 to 114 described above. Therefore, the processes of Steps 123 and 124 are for confirmation, and may be omitted as unnecessary.

Subsequently, the control circuit 50 changes the gripping command of the piece of cloth C to the second hand 12 from the tight gripping command to the soft gripping command. Then, the control circuit 50 generates an operation command (third movement command) that causes the second hand 12 to move relative to the piece of cloth C at a constant velocity toward another corner portion adjacent to the corner portion of the piece of cloth C gripped by the first hand 11 while keeping the gripping operation (soft gripping operation) of the end portion of the piece of cloth C by the second hand 12 (Step 125 in FIG. 11).

The movement direction of the second hand 12 is typically a direction away from the first hand 11 horizontally. It should be noted that the movement direction of the second hand 12 can be determined based on a pressure distribution detected by the second pressure distribution sensors 42 as in Step 119 described above.

During the movement of the second hand 12, the determination unit 53 determines whether or not the second hand 12 reaches the corner portion of the piece of cloth C on the basis of the outputs of the second pressure distribution sensors 42 (Step 126).

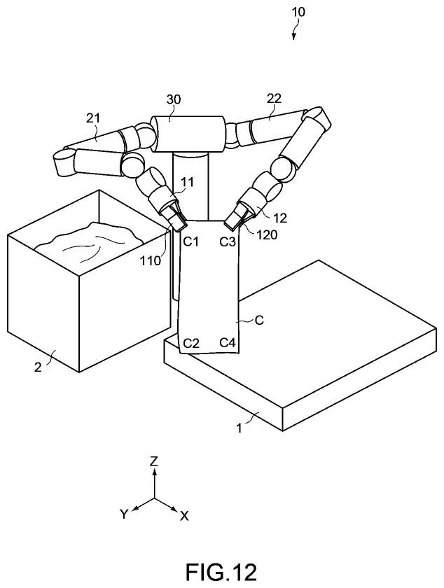

When the second hand 12 reaches the corner portion of the piece of cloth C, the control circuit 50 stops the movement of the second hand 12 and changes the gripping force on the piece of cloth C at that position from the soft gripping command to the tight gripping command. Accordingly, the first hand 11 stably grips the other corner portion of the piece of cloth C (see FIG. 12).

In the above-mentioned manner, the robot apparatus 10 performs a spreading operation of the piece of cloth C.

In accordance with the present embodiment, gripping the piece of cloth C with one hand of the first and second hands 11, 12 while moving the other hand relative to the piece of cloth C enables the end portion of the piece of cloth C to be detected and gripped by the other hand. Therefore, the end portion of the piece of cloth C can be detected and gripped even in a case where the piece of cloth C is casually placed.

In addition, in accordance with the present embodiment, one hand of the first or second hand 11, 12 grips the end portion of the piece of cloth C while the other hand detects and grips the corner portion of the piece of cloth C. Therefore, an operation of gripping two corner portions of the piece of cloth C by the first and second hands 11, 12, which is required for the spreading operation of the piece of cloth C, can be automatically performed.

(Folding Process)

Next, details of the folding process of the piece of cloth C (Step 2 in FIG. 5) will be described.

Here, the control circuit 50 generates a folding command to fold a corner portion of the piece of cloth C to meet another one. Specifically, provided that the four corner portions of the piece of cloth C are first to fourth corner portions C1 to C4, respectively, as shown in FIG. 12, the control circuit 50 causes the robot apparatus 10 to perform an operation of causing the first corner portion C1 gripped by the first hand 11 to meet the second corner portion C2, which is opposite to the first corner portion C1 in the gravity direction (vertically), and causing the third corner portion C3 gripped by the second hand 12 to meet the fourth corner portion C4, which is opposite to the third corner portion C3 in the gravity direction (vertically).

### Operation Example 1

Here, a case of folding the piece of cloth C in two will be exemplified and described as an operation example of folding the piece of cloth C on the work table 1.

Here, the surface of the work table 1 has a friction coefficient that can produce a certain frictional force on the piece of cloth C when it is in contact with the piece of cloth C.

It should be noted that in FIG. 12, the X-axis, the Y-axis, and the Z-axis denote three axis directions orthogonal to one another and the Z-axis corresponds to the vertical direction.

First of all, as shown in FIG. 12, the control circuit 50 moves the piece of cloth C to directly above the work table 1 with the first hand 11 and the second hand 12 retaining (tightly gripping) the first corner portion C1 and the third corner portion C3 at the both ends on the upper side of the piece of cloth C, respectively. At this time, the first hand 11 and the second hand 12 are arranged on an axis line parallel to the Y-axis direction while applying a constant tensile force on the piece of cloth C, for example, and arranged at such a height position that the lower end portion of the piece of cloth C does not touch the work table 1.

Subsequently, the control circuit 50 simultaneously moves the first and second hands 11, 12 downward in the Z-axis direction until the lower end portion of the piece of cloth C touches the work table 1. Whether or not the lower end portion of the piece of cloth C touches the work table 1 can be detected based on a change in weight of the piece of cloth C acting on the first and second hands 11, 12.

After the contact of the piece of cloth C with the work table 1 is detected, the control circuit 50 moves the first and second hands 11, 12 downward and at the same time moves the first and second hands 11, 12 forward (in FIG. 12, in a negative direction on the X-axis) as viewed from the robot apparatus 10 by the same amount of movement as the amount of downward movement. This operation continues until it reaches a half of a vertical length of the piece of cloth C.

It should be noted that the storage unit 54 stores the length of each side of the piece of cloth C as a known value. Therefore, the vertical length of the piece of cloth C can be determined based on a distance between the corner portions C1 and C3 gripped by the first and second hands 11, 12.

It should be noted that the length of each side of the piece of cloth C does not necessarily need to be known, and may be detected by a certain method. For example, the vertical length of the piece of cloth C can be detected based on vertical positions of the first and second hands 11, 12 when the piece of cloth C touches the work table 1. Moreover, a horizontal length of the piece of cloth C can be detected based on horizontal positions of the first and second hands 11, 12 gripping the corner portions C1 and C2.

After the half of the piece of cloth C is placed on the work table 1, the control circuit 50 inverts the movement directions of the first and second hands 11, 12 in the X-axis direction, and moves the first and second hands 11, 12 downwards and at the same time moves in a deep direction (in FIG. 12, a positive direction on the X-axis) as viewed from the robot apparatus 10.

Keeping such an operation as it is causes the corner portions C1 and C3 meet the corner portions C2 and C4 on the work table 1, respectively. As a result, the piece of cloth C is half-folded.

### Operation Example 2

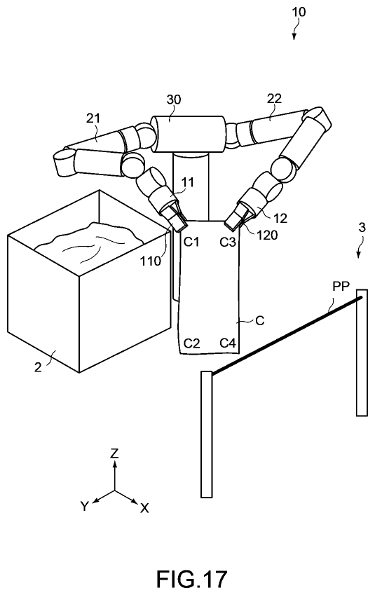

Next, an example of half-folding the piece of cloth C without using the work table 1 will be described. Here, as shown in FIG. 17, a method using a working jig 3 provided with a bar PP having a certain friction coefficient, which is arranged to be parallel to the Y-axis direction at a height position higher than a half of the vertical length of the piece of cloth C, will be described.

First of all, as shown in FIG. 17, the control circuit 50 moves the piece of cloth C in the deep direction of the robot apparatus 10 to such a position that the lower end portion of the piece of cloth C goes beyond the bar PP with the first hand 11 and the second hand 12 retaining (tightly gripping) the first corner portion C1 and the third corner portion C3 at the both ends on the upper side of the piece of cloth C, respectively. At this time, the first hand 11 and the second hand 12 are arranged on the axis line parallel to the Y-axis direction while applying a constant tensile force on the piece of cloth C, for example.

Next, the control circuit 50 moves the first and second hands 11, 12 in the Z-axis direction so that a middle position of the vertical length of the piece of cloth C comes to the height position of the bar P. Then, the control circuit 50 moves the first and second hands 11, 12 forward as viewed from the robot apparatus 10 to such positions that the middle position of the vertical length of the piece of cloth C touches the bar PP.

After the piece of cloth C touches the bar PP, the control circuit 50 moves the first and second hands 11, 12 in an XZ-plane along a circular-arc trajectory having the bar PP as its center and the half of the vertical length of the piece of cloth C as its radius while keeping the tension of the piece of cloth C. The first and second hands 11, 12 rotate on such a circular-arc trajectory by about 180 degrees as an angle of rotation. It should be noted that whether or not the piece of cloth C touches the bar PP can be detected based on a change in weight of the piece of cloth C acting on the first and second hands 11, 12.

Subsequently, after the first and second hands 11, 12 reach the lowest point of the circular-arc trajectory, the control circuit 50 cancels the gripping operation of the piece of cloth C by the first and second hands 11, 12. Accordingly, the corner portions C1 and C3 meet the corner portions C2 and C4 in the X-axis direction, respectively. Then, the first and second hands 11, 12 gripping and lifting both left and right end portions of the piece of cloth C put on the bar PP can take out the piece of cloth C half-folded vertically from the bar PP.

### Modified Examples

In the above-mentioned embodiments, the robot apparatus 10 configured to be capable of half-folding the rectangular piece of cloth C is exemplified and described. The present technology is not limited thereto. The present technology can be applied to various applications for handling the flexible thin object.

For example, the present technology can be applied to a task of finding and gripping edges or corners of pieces of cloth such as bed sheets, towels, and Yukatas casually stacked after cleaning or drying, a task of setting the above-mentioned piece of cloth for the use of a professional iron or folding apparatus, and a task of putting a bed sheet or the like off from a predetermined position such as a bed, for example.

Moreover, in the above-mentioned embodiments, the dual-arm robot apparatus provided with the first arm 21 and the second arm 22 is exemplified and described as the robot apparatus 10. The present technology is not limited thereto. A robot with three or more arms may be employed.

Similarly, the first and second finger units 110, 120 provided in the first and second hands 11, 12 are not limited to the two finger grippers, and finger units with three or more finger portions may be employed.

It should be noted that the present technology may also take the following configurations.
(1) A control apparatus, including:
   an acquisition unit that acquires an output of a first pressure distribution sensor arranged on a gripping surface of a first hand and an output of a second pressure distribution sensor arranged on a gripping surface of a second hand;
   an operation command generation unit that generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand; and
   a determination unit that determines whether or not the second hand reaches an end portion of the flexible thin object on the basis of the output of the second pressure distribution sensor.
(2) The control apparatus according to (1), in which
   the operation command generation unit further generates a second gripping command for causing the first hand to grip a second predetermined portion that is proximity of the end portion of the flexible thin object gripped by the second hand, and
   the determination unit further determines whether or not the second predetermined portion is the end portion of the flexible thin object on the basis of the output of the first pressure distribution sensor.
(3) The control apparatus according to (2), in which
   the operation command generation unit repeatedly generates the second gripping command until the first hand grips another end portion different from the one end portion of the flexible thin object with the second hand gripping one end portion of the flexible thin object.
(4) The control apparatus according to (3), in which
   the operation command generation unit further generates a second movement command for moving the first hand relative to the flexible thin object toward a corner portion of the flexible thin object while keeping a gripping operation of the flexible thin object by the first hand.
(5) The control apparatus according to (4), in which
   the operation command generation unit further generates a third movement command for moving the second hand relative to the flexible thin object toward another corner portion of the flexible thin object while keeping the gripping operation of the flexible thin object by the second hand with the first hand gripping one corner portion of the flexible thin object.
(6) The control apparatus according to any one of (1) to (5), in which
   the predetermined direction is a gravity direction.
(7) The control apparatus according to any one of (1) to (6), in which
   the acquisition unit further acquires information about a facing distance between gripping surfaces of the second hand gripping the first predetermined portion, and
   the determination unit determines whether or not the first predetermined portion gripped by the second hand has a thickness of a single piece of the flexible thin object on the basis of the information about the facing distance.
(8) The control apparatus according to any one of (1) to (7), in which
   the determination unit determines that the second hand reaches the end portion of the flexible thin object when the determination unit determines, on the basis of a pressure distribution detected by the second pressure distribution sensor, that a boundary portion between a first region where a pressure value is a predetermined value or more and a second region where the pressure value is less than the predetermined value extends in at least one arbitrary axis direction.
(9) The control apparatus according to (8), in which
   the determination unit determines that the second hand reaches the corner portion of the flexible thin object when the determination unit determines that the boundary portion between the first region and the second region extends in two axis directions intersecting with each other.
(10) The control apparatus according to (2), in which
   the determination unit determines that the second predetermined portion is the end portion of the flexible thin object when the determination unit determines, on the basis of a pressure distribution detected by the first pressure distribution sensor, that a boundary portion between a first region where a pressure value is a predetermined value or more and a second region where the pressure value is less than the predetermined value extends in at least one arbitrary axis direction.
(11) The control apparatus according to any one of (1) to (10), in which
   the acquisition unit further acquires information about weight of the flexible thin object gripped by the first hand, and
   the determination unit determines whether or not weight of the flexible thin object gripped by the first hand is weight of a single piece of the flexible thin object on the basis of the information about the weight.
(12) The control apparatus according to (5), in which
   the operation command generation unit further generates a folding command for causing corner portions of the flexible thin object to meet each other.
(13) The control apparatus according to (12), in which
   the folding command performs an operation of causing a first corner portion gripped by the first hand to meet a second corner portion and causing a third corner portion gripped by the second hand to meet a fourth corner portion, the second corner portion being opposite to the first corner portion in a gravity direction, the fourth corner portion being opposite to the third corner portion in the gravity direction.
(14) A robot apparatus, including:
   a first pressure distribution sensor arranged on a gripping surface of a first hand;
   a second pressure distribution sensor arranged on a gripping surface of a second hand;
   a control circuit including
      an acquisition unit that acquires an output of the first pressure distribution sensor and an output of the second pressure distribution sensor,
      an operation command generation unit that generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand, and
      a determination unit that determines whether or not the second hand reaches an end portion of the flexible thin object on the basis of the output of the second pressure distribution sensor.
(15) A control method for a robot apparatus, including:
   causing a second hand to grip a first predetermined portion of the flexible thin object gripped by a first hand;
   moving the second hand relative to the flexible thin object in a predetermined direction from the first predetermined portion while keeping a gripping operation of the flexible thin object by the second hand; and
   determining whether or not the second hand reaches an end portion of the flexible thin object on the basis of the output of a second pressure distribution sensor arranged on a gripping surface of the second hand.
(16) A program that causes a control apparatus of a robot apparatus to execute:
   a step of causing a second hand to grip a first predetermined portion of the flexible thin object gripped by a first hand;
   a step of moving the second hand relative to the flexible thin object in a predetermined direction from the first predetermined portion while keeping a gripping operation of the flexible thin object by the second hand; and
   a step of determining whether or not the second hand reaches an end portion of the flexible thin object on the basis of the output of a second pressure distribution sensor arranged on a gripping surface of the second hand.

### REFERENCE SIGNS LIST

10 robot apparatus
11 first hand
12 second hand
30 drive unit
41 first pressure distribution sensor
42 second pressure distribution sensor
50 control circuit (control apparatus)
51 acquisition unit
52 operation command generation unit
53 determination unit
C piece of cloth (flexible thin object)

1. A control apparatus, comprising:
an acquisition unit that acquires an output of a first pressure distribution sensor arranged on a gripping surface of a first hand and an output of a second pressure distribution sensor arranged on a gripping surface of a second hand;
an operation command generation unit that generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand; and
a determination unit that determines whether or not the second hand reaches an end portion of the flexible thin object on a basis of the output of the second pressure distribution sensor.

2. The control apparatus according to claim 1, wherein
the operation command generation unit further generates a second gripping command for causing the first hand to grip a second predetermined portion that is proximity of the end portion of the flexible thin object gripped by the second hand, and
the determination unit further determines whether or not the second predetermined portion is the end portion of the flexible thin object on a basis of the output of the first pressure distribution sensor.

3. The control apparatus according to claim 2, wherein
the operation command generation unit repeatedly generates the second gripping command until the first hand grips another end portion different from the one end portion of the flexible thin object with the second hand gripping one end portion of the flexible thin object.

4. The control apparatus according to claim 3, wherein
the operation command generation unit further generates a second movement command for moving the first hand relative to the flexible thin object toward a corner portion of the flexible thin object while keeping a gripping operation of the flexible thin object by the first hand.

5. The control apparatus according to claim 4, wherein
the operation command generation unit further generates a third movement command for moving the second hand relative to the flexible thin object toward another corner portion of the flexible thin object while keeping the gripping operation of the flexible thin object by the second hand with the first hand gripping one corner portion of the flexible thin object.

6. The control apparatus according to claim 1, wherein
the predetermined direction is a gravity direction.

7. The control apparatus according to claim 1, wherein
the acquisition unit further acquires information about a facing distance between gripping surfaces of the second hand gripping the first predetermined portion, and
the determination unit determines whether or not the first predetermined portion gripped by the second hand has a thickness of a single piece of the flexible thin object on a basis of the information about the facing distance.

8. The control apparatus according to claim 1, wherein
the determination unit determines that the second hand reaches the end portion of the flexible thin object when the determination unit determines, on a basis of a pressure distribution detected by the second pressure distribution sensor, that a boundary portion between a first region where a pressure value is a predetermined value or more and a second region where the pressure value is less than the predetermined value extends in at least one arbitrary axis direction.

9. The control apparatus according to claim 8, wherein
the determination unit determines that the second hand reaches the corner portion of the flexible thin object when the determination unit determines that the boundary portion between the first region and the second region extends in two axis directions intersecting with each other.

10. The control apparatus according to claim 2, wherein
the determination unit determines that the second predetermined portion is the end portion of the flexible thin object when the determination unit determines, on a basis of a pressure distribution detected by the first pressure distribution sensor, that a boundary portion between a first region where a pressure value is a predetermined value or more and a second region where the pressure value is less than the predetermined value extends in at least one arbitrary axis direction.

11. The control apparatus according to claim 1, wherein
the acquisition unit further acquires information about weight of the flexible thin object gripped by the first hand, and
the determination unit determines whether or not weight of the flexible thin object gripped by the first hand is weight of a single piece of the flexible thin object on a basis of the information about the weight.

12. The control apparatus according to claim 5, wherein
the operation command generation unit further generates a folding command for causing corner portions of the flexible thin object to meet each other.

13. The control apparatus according to claim 12, wherein
the folding command performs an operation of causing a first corner portion gripped by the first hand to meet a second corner portion and causing a third corner portion gripped by the second hand to meet a fourth corner portion, the second corner portion being opposite to the first corner portion in a gravity direction, the fourth corner portion being opposite to the third corner portion in the gravity direction.

14. A robot apparatus, comprising:
a first pressure distribution sensor arranged on a gripping surface of a first hand;
a second pressure distribution sensor arranged on a gripping surface of a second hand;
a control circuit including
an acquisition unit that acquires an output of the first pressure distribution sensor and an output of the second pressure distribution sensor,
an operation command generation unit that generates a first gripping command for causing the second hand to grip a first predetermined portion of the flexible thin object gripped by the first hand and a first movement command for moving the second hand relative to the flexible thin object in a predetermined direction from the first predetermined portion while keeping a gripping operation of the flexible thin object by the second hand, and
a determination unit that determines whether or not the second hand reaches an end portion of the flexible thin object on a basis of the output of the second pressure distribution sensor.

15. A control method for a robot apparatus, comprising:
causing a second hand to grip a first predetermined portion of the flexible thin object gripped by a first hand;
moving the second hand relative to the flexible thin object in a predetermined direction from the first predetermined portion while keeping a gripping operation of the flexible thin object by the second hand; and
determining whether or not the second hand reaches an end portion of the flexible thin object on a basis of the output of a second pressure distribution sensor arranged on a gripping surface of the second hand.

16. A program that causes a control apparatus of a robot apparatus to execute:
a step of causing a second hand to grip a first predetermined portion of the flexible thin object gripped by a first hand;
a step of moving the second hand relative to the flexible thin object in a predetermined direction from the first predetermined portion while keeping a gripping operation of the flexible thin object by the second hand; and
a step of determining whether or not the second hand reaches an end portion of the flexible thin object on a basis of the output of a second pressure distribution sensor arranged on a gripping surface of the second hand.
